(19) United States
(12) Patent Application Publication
(10) Pub. No.: US 2026/0220433 A1
(43) Pub. Date: Jul. 30, 2026

(54) System and method for dynamically updating and rectifying machine-learning models determined to be underperforming

(71) Applicant: Bank of America Corporation, Charlotte, NC (US)

(72) Inventors: Sivashalini Sivajothi, Chennai (IN); Maneesh Kumar Sethia, Hyderabad (IN); Shameera Roohin Mohammed Nasrullah, Chengalpattu (IN); Parameswari K, Chennai (IN)

(21) Appl. No.: 19/041,489

(22) Filed: Jan. 30, 2025

(51) Int. Cl. G06N 3/0455; G06N 3/08

(52) U.S. Cl. CPC G06N 3/0455; G06N 3/08

(57) ABSTRACT

A system includes a memory configured to store a set of input data. The set of input data includes a first set of feature data associated with a machine-learning model. The machine-learning model is identified as having generated one or more prediction outputs that deviate from an expected prediction output. The system includes a processor operably coupled to the memory and configured to access the first set of feature data, execute a first machine-learning model of one or more generative machine-learning models, execute a second machine-learning model of the one or more generative machine-learning models, generate a set of output data based at least in part on the regenerated first set of feature data, and in response to determining that the set of output data satisfies a predetermined accuracy threshold, provide the set of output data to the machine-learning model.

### TECHNICAL FIELD

The present disclosure relates generally to computing performance and security, and, more specifically, to a system and method for dynamically updating and rectifying machine-learning models determined to be underperforming.

### BACKGROUND

Machine-learning models may generally include predictive or statistical models trained on large data sets for generating prediction outputs in response to being inputted a new, but similar data set. However, because many machine-learning models may be generally trained, validated, and evaluated by an entity prior to, and distinct from the entity that may later deploy the machine-learning models for generating prediction outputs on application-specific and client-specific data sets, many existing machine-learning models may underperform or perform poorly when applied to the application-specific and client-specific data sets.

### SUMMARY

The system and methods implemented by the system as disclosed in the present disclosure provide technical solutions to the technical problems discussed above by dynamically updating and rectifying machine-learning models determined to be underperforming. The disclosed system and methods provide several practical applications and technical advantages. Specifically, the present embodiments improve the performance, accuracy, and maintainability of software applications and systems employing artificial intelligence, namely, machine-learning models, as well as the one or more hardware processors and memory on which the software applications and systems may be executed and stored.

Indeed, in accordance with the presently disclosed embodiments, identified is an active machine-learning model, which is generating one or more prediction outputs that deviate from an expected prediction output. The active machine-learning model (e.g., codebase, algorithm, logic, training data, features, learned parameters, model parameters, deviations, and so forth) may be then provided to an evaluation machine-learning model. In particular embodiments, the evaluation machine-learning model may be then in real-time or near real-time trained and validated in accordance with a self-supervised learning (SSL) process based on the active machine-learning model and executed to generate one or more model performance metrics associated with the active machine-learning model.

For example, in particular embodiments, the model performance metrics may include one or more of a fitness score, an accuracy performance metric, a precision performance metric, a prediction uncertainty performance metric, a receiver operating characteristic (ROC) curve performance metric, an area under curve (AUC) performance metric, a true positive rate (TPR) performance metric, a false positive rate (FPR), or an F1 score performance metric. The model performance metrics associated with the active machine-learning model may be then compared to a performance metric threshold (e.g., ROC threshold, AUC threshold, TPR threshold, FPR threshold, F1 score threshold, and so forth) to identify and quantify in real-time or near real-time the active machine-learning model as underperforming.

In particular embodiments, upon the evaluation machine-learning model identifying and quantifying the active machine-learning model as underperforming, the active machine-learning model (e.g., codebase, algorithm, logic, training data, features, learned parameters, model parameters, deviations, and so forth) and the model performance metrics may be then provided to a hybrid machine-learning model that may be trained to identify patterns of deviation of the one or more prediction outputs and inconsistent features in the training data set or input data set associated with the active machine-learning model based on the active machine-learning model and the model performance metrics. Specifically, in accordance with the presently-disclosed embodiments, the hybrid machine-learning model may be utilized to identify significant contributors (e.g., inconsistent features, quality of training data sets, overfitting and underfitting, quantity of training data) to the machine-learning model having generated the one or more prediction outputs that deviate from the expected prediction output.

For example, in one embodiment, the hybrid machine-learning model may include a k-nearest neighbor (KNN) machine-learning model configured to identify the inconsistent features by performing one or more of a classification or regression based on the performance metrics and the training data set or input data set associated with the active machine-learning model. In another embodiment, the hybrid machine-learning model may include a support vector machine (SVM) configured to identify the patterns of deviation by performing one or more of a classification or regression based on the model performance metrics and the one or more prediction outputs.

Specifically, by including the KNN model, the hybrid machine-learning model may be uniquely suitable for executing on training data sets or input data sets that include inconsistent features (e.g., missing features, missing values, null values, irrelevant features, outlier features). Similarly, by including the SVM, the hybrid machine-learning model may be uniquely suitable for determining a hyperplane that best separates the patterns of deviations into separate domains. In this way, the hybrid machine-learning model may be utilized to identify and quantify the “how” and “why” as to the reason the active machine-learning model is generating the one or more prediction outputs that deviate from the expected prediction output.

In particular embodiments, upon the hybrid machine-learning model identifying patterns of deviation of the one or more prediction outputs and inconsistent features in the training data set or input data set associated with the active machine-learning model, the identified patterns of deviation and the inconsistent features may be then passed to a diffusion machine-learning model that may be trained and executed to rectify the active machine-learning model by imputing the inconsistent features (e.g., missing features, missing values, null values, irrelevant features, outlier features) and correcting the patterns of deviation.

For example, in particular embodiments, the diffusion machine-learning model may include a forward diffusion encoder that may be trained and executed 1) to combine a first set of feature data associated with the active machine-learning model and a set of noisy deviation data associated with the one or more prediction outputs, and 2) to identify, based on the combined first set of feature data and the set of noisy deviation data, a set of noise data and a second set of feature data. In one embodiment, the second set of feature data may include a set of deviation data combined with the first set of feature data. In particular embodiments, the diffusion machine-learning model may further include a reverse diffusion decoder that may be trained and executed to regenerate the first set of feature data by removing the set of deviation data from the second set of feature data.

Specifically, in accordance with the presently-disclosed embodiments, the forward diffusion encoder of the diffusion machine-learning model may be trained and executed to introduce a set of noisy deviation data to the first set of feature data and predict from the combination the set of noisy deviation data, the set of noise data, and the second set of feature data. Similarly, the reverse diffusion decoder of the diffusion machine-learning model may be trained and executed to regenerate the first set of feature data by subtracting the set of deviation data from the second set of feature data. In other words, the reverse diffusion decoder of the diffusion machine-learning model may regenerate consistent feature data for the active machine-learning model, and thus rectify and fine-tune the active machine-learning model by imputing inconsistent feature data within the second set of feature data.

In particular embodiments, the diffusion machine-learning model may then generate a set of output data based on the regenerated first set of feature data. In response to determining that the set of output data satisfies a predetermined accuracy threshold, the diffusion machine-learning model may then provide the set of output data to the active machine-learning model based on which the active machine-learning model may be retrained and/or fine-tuned. In this way, the present embodiments may in real-time or near real-time rectify and fine-tune the active machine-learning model, such that the active machine-learning model subsequently generates prediction outputs in accordance with its expected prediction output.

Thus, the present embodiments may improve the performance, accuracy, and maintainability of software applications and systems employing artificial intelligence, and, namely, machine-learning models, as well as the one or more hardware processors and memory on which the software applications and systems may be executed and stored. It accomplishes these technical benefits by training and executing a machine-learning model evaluation and rectification system (e.g., evaluation machine-learning model, hybrid machine-learning model, and diffusion machine-learning model) in real-time or near real-time 1) to identify and quantify an active machine-learning model as underperforming, 2) to identify patterns of deviation of the prediction outputs of the active machine-learning model and inconsistent features in the training data set or input data set associated with the active machine-learning model, and 3) to rectify and fine-tune the active machine-learning model by imputing the inconsistent features (e.g., missing features, missing values, null values, irrelevant features, outlier features) and correcting the patterns of deviation, the present embodiments may lead to improved performance, accuracy, and maintainability of software applications and systems employing artificial intelligence, and, namely, machine-learning models. Thus, the present disclosure addresses problems rooted in software applications and systems that employe artificial intelligence.

Particularly, the present embodiments may lead to improved performance, accuracy, and maintainability of software applications and systems employing artificial intelligence, and, namely, machine-learning models by improving the performance and accuracy (e.g., in terms of receiver operating characteristic (ROC) curve, an area under curve (AUC), true positive rate (TPR), false positive rate (FPR), F1 score, and so forth) in the prediction outputs and decision-making capability of the active machine-learning model identified as underperforming in real-time or near real-time.

As an extension of the performance and accuracy in the prediction outputs and decision-making capability of the active machine-learning model identified as underperforming being improved in real-time or near real-time by way of self-supervised evaluation, data and feature imputation, and fine-tuning, the present embodiments may further preempt any necessity of retraining the active machine-learning model identified as underperforming due to the learned parameters (e.g., trained weights) being evaluated and fine-tuned in much more streamlined and judicious manner by way parameter-efficient fine-tuning (PEFT) (e.g., as compared to retraining all tens of millions or hundreds of millions of learned parameters of the active machine-learning model as would otherwise be required when a machine-learning model repeatedly underperforms). In this way, the machine-learning model evaluation and rectification system as presently disclosed herein may reduce processor execution times, processing workloads, and memory storage requirements of the processor and memory on which the active machine-learning model identified as underperforming is trained, validated, and executed.

The present embodiments are directed to systems and methods for dynamically updating and rectifying machine-learning models determined to be underperforming. In particular embodiments, a system includes a memory configured to store a set of input data. In one embodiment, the set of input data may include a first set of feature data associated with a machine-learning model. In particular embodiments, the machine-learning model is identified as having generated one or more prediction outputs that deviate from an expected prediction output. In particular embodiments, the system further includes one or more processors operably coupled to the memory and configured to access the first set of feature data.

In particular embodiments, the one or more processors may be further configured to execute a first machine-learning model of one or more generative machine-learning models. In particular embodiments, the first machine-learning model may be trained 1) to combine the first set of feature data and a set of noisy deviation data associated with the one or more prediction outputs, and 2) to identify, based at least in part on the combined first set of feature data and the set of noisy deviation data, a set of noise data and a second set of feature data. For example, in one embodiment, the second set of feature data may include a set of deviation data combined with the first set of feature data.

In particular embodiments, the one or more processors may be further configured to execute a second machine-learning model of the one or more generative machine-learning models. In particular embodiments, the second machine-learning model may be trained to regenerate the first set of feature data by removing the set of deviation data from the second set of feature data. In particular embodiments, the one or more generative machine-learning models may include a diffusion machine-learning model. For example, in one embodiment, the diffusion machine-learning model may include one or more of a fully convolutional network (FCN), a U-Net diffusion model, a Midjourney diffusion model, a Stable Diffusion model, a DALL-E diffusion, or a denoising diffusion probabilistic model (DDPM).

In particular embodiments, the first machine-learning model may include a forward diffusion encoder of the diffusion machine-learning model. In particular embodiments, the second machine-learning model may include a reverse diffusion decoder of the diffusion machine-learning model. In particular embodiments, the one or more processors may be further configured to generate a set of output data based at least in part on the regenerated first set of feature data.

In particular embodiments, in response to determining that the set of output data satisfies a predetermined accuracy threshold, the one or more processors may be further configured to provide the set of output data to the machine-learning model. In particular embodiments, the one or more processors may be further configured to fine-tune the machine-learning model based at least in part on the set of output data. In particular embodiments, the second machine-learning model may be further trained to regenerate the first set of feature data by imputing one or more inconsistent features in the second set of feature data.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a block diagram of a cloud computing system, in accordance with certain aspects of the present disclosure;

FIG. 2 illustrates a workflow diagram of an embodiment of a model evaluation and rectification system, in accordance with certain aspects of the present disclosure;

FIG. 3 illustrates a flowchart of an example method for performing a self-supervised training, validation, and execution of an evaluation model for evaluating underperforming machine-learning models, in accordance with one or more embodiments of the present disclosure;

FIG. 4 illustrates a flowchart of an example method for identifying and quantifying deviations and inconsistent features in machine-learning models, in accordance with one or more embodiments of the present disclosure; and

FIG. 5 illustrates a flowchart of an example method for dynamically updating and rectifying machine-learning models determined to be underperforming, in accordance with one or more embodiments of the present disclosure.

### DETAILED DESCRIPTION

### Example System

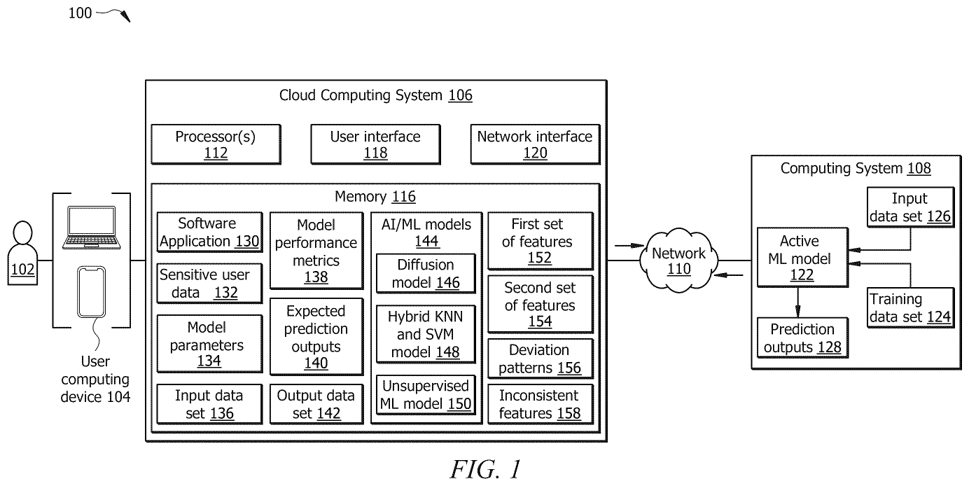

FIG. 1 is a block diagram of a cloud computing and hardware computing resources system 100. In particular embodiments, the system 100 may include a user computing device 104 associated with a user 102, a cloud computing system 106, computing system 108, and a network 110. In particular embodiments, the user 102 may include a user associated with an institution, an organization, or an entity that receives user data and hosts and maintain sensitive user data (e.g., sensitive user data 132) that may be associated with the user 102. The network 110 enables communications and exchanges of data among components of the system 100, such as the user computing device 104, the cloud computing system 106, and the computing system 108.

In general, the system 100 may be utilized 1) to perform a self-supervised training, validation, and execution of an evaluation machine model 150 of one or more generative machine-learning models 144 for evaluating an active machine-learning model 122 identified as underperforming (e.g., generating prediction outputs 128 that deviate from expected prediction outputs 140 in response to an input of one or more of a training data set 124 or an input data set 126); 2) to identify and quantify patterns of deviation 156 and inconsistent features 158 associated with the active machine-learning model 122; and 3) to dynamically update and rectify the active machine-learning model 122 determined to be underperforming.

As used herein, an “underperformance,” “underperforming,” or a “poorly performing” machine-learning model may refer to one or more instances in which one or more prediction outputs generated by a machine-learning model fails to correspond to one or more expected prediction outputs for the machine-learning model, and, further, the deviations (e.g., differences) between the one or more prediction outputs generated by the machine-learning model and the one or more expected prediction outputs generated by the machine-learning model is equal to or less than a prediction accuracy of “0.7” (e.g., prediction outputs are accurate 70% of the time or less) on a prediction accuracy scale of “0.0” to “1.0,” in which a prediction accuracy of “1.0” may indicate a highest likelihood of model prediction accuracy while a prediction accuracy of “0.0” may indicate a lowest likelihood of model prediction accuracy. For example, in an embodiment in which a machine-learning model includes an image classifier trained to accurately predict a class label of “dog” for a data set of images of different animals when an image includes a dog, an “underperforming” or “poorly performing” machine-learning model may accurately label an image of a dog as “dog” within the data set of images of different animals at best only 70% of the time while 30% of the time, for example, predicting a class label of “dog” for images of other four-legged animals (e.g., cats).

Furthermore, as used herein, a “feature” may refer to one or more variables or individual measurable properties in a data set (e.g., training data set, validation data set, testing data set, input data set) that is most impactful to a machine-learning model's performance in generating accurate prediction outputs in response to the inputted data set. Similarly, “inconsistent features” may include any missing features, any missing values, any null values, any irrelevant features, any outlier features, or any other features included as part of, for example, a training data set or an input data set that may be contributing to a machine-learning model underperforming or otherwise performing poorly (e.g., generating prediction outputs that do not correspond to expected prediction outputs) on the training data set or the input data set.

In particular embodiments, the cloud computing system 106 may include one or more processor(s) 112 in signal communication with a memory 116. The memory 116 stores software application 130 that when executed by the processor(s) 112, cause the processor(s) 112 to perform one or more functions described herein. For example, when the software application 130 is executed, the processor(s) 112 1) performs a self-supervised training, validation, and execution of an evaluation machine model 150 of one or more generative machine-learning models 144 for evaluating an active machine-learning model 122 identified as underperforming (e.g., generating prediction outputs 128 that deviate from expected prediction outputs 140 in response to an input of one or more of a training data set 124 or an input data set 126); 2) identifies and quantify patterns of deviation 156 and inconsistent features 158 associated with the active machine-learning model 122; and 3) dynamically updates and rectifies the active machine-learning model 122 determined to be underperforming.

The cloud computing system 100 may be configured as shown, or in any other configuration. In one embodiment, the cloud computing system 106 may include a private cloud computing and storage system, which may include, for example, a cloud computing environment and infrastructure that may be managed, controlled, and dedicated to a single organization or entity. In another embodiment, the cloud computing system 106 may include a hybrid cloud computing and storage system, which may include, for example, a mixed computing environment and infrastructure in which software applications are executing utilizing some combination of computing, storage, and services in both private cloud environments and public cloud environments. Still, in another embodiment, the cloud computing system 106 may include a public cloud computing and storage system, which may include, for example, a cloud computing environment and infrastructure that may be serviced to any number of organizations or entities as virtual resources accessible over the internet.

### System Components

### Network

The network 110 may be any suitable type of wireless and/or wired network, including, but not limited to, all or a portion of the Internet, an Intranet, a private network, a public network, a peer-to-peer network, the public switched telephone network, a cellular network, a local area network (LAN), a metropolitan area network (MAN), a wide area network (WAN), and a satellite network. The network 110 may be configured to support any suitable type of communication protocol as would be appreciated by one of ordinary skill in the art.

### Cloud Computing System

In particular embodiments, the cloud computing system 106 may include any computing system that may be utilized to process data and communicate with computing devices (e.g., user computing device 104), databases, or computing systems (e.g., computing system 108) via the network 110. The cloud computing system 106 may be utilized to oversee operations of the processor(s) 112. In particular embodiments, the cloud computing system 106 may include the processor(s) 112 in signal communication with a network interface 120, a user interface 118, and memory 116. The cloud computing system 106 may be configured as shown, or in any other configuration.

The processor(s) 112 may include one or more processors operably coupled to the memory 116. The processor(s) 112 is any electronic circuitry, including, but not limited to, state machines, one or more central processing unit (CPU) chips, logic units, cores (e.g., a multi-core processor), field-programmable gate arrays (FPGAs), application-specific integrated circuits (ASICs), or digital signal processors (DSPs). The processor(s) 112 may be a programmable logic device, a microcontroller, a microprocessor, or any suitable combination of the preceding. The processor(s) 112 may be communicatively coupled to and in signal communication with the network interface 120, user interface 118, and memory 116. The one or more processors may be utilized to process data and may be implemented in hardware, software, or some combination thereof.

For example, the processor(s) 112 may be 8-bit, 16-bit, 32-bit, 64-bit or of any other suitable architecture. The processor(s) 112 may include an arithmetic logic unit (ALU) for performing arithmetic and logic operations, processor registers that supply operands to the ALU and store the results of ALU operations, and a control unit that fetches instructions from memory and executes them by directing the coordinated operations of the ALU, registers and other components. The one or more processor(s) 112 are configured to implement various instructions. For example, the one or more processors may be utilized to execute software application 130 to implement the functions disclosed herein, such as some or all of those described with respect to FIGS. 1-5. In some embodiments, the function described herein is implemented using logic units, FPGAs, ASICs, DSPs, or any other suitable hardware or electronic circuitry.

The network interface 120 may be utilized to enable wired and/or wireless communications (e.g., via the network 110). The network interface 120 may be utilized to communicate data between the cloud computing system 106 and other network devices, systems, or domain(s). For example, the network interface 120 may comprise a WIFI interface, a local area network (LAN) interface, a wide area network (WAN) interface, a modem, a switch, or a router. The processor(s) 112 may be configured to send and receive data using the network interface 120. The network interface 120 may be configured to use any suitable type of communication protocol.

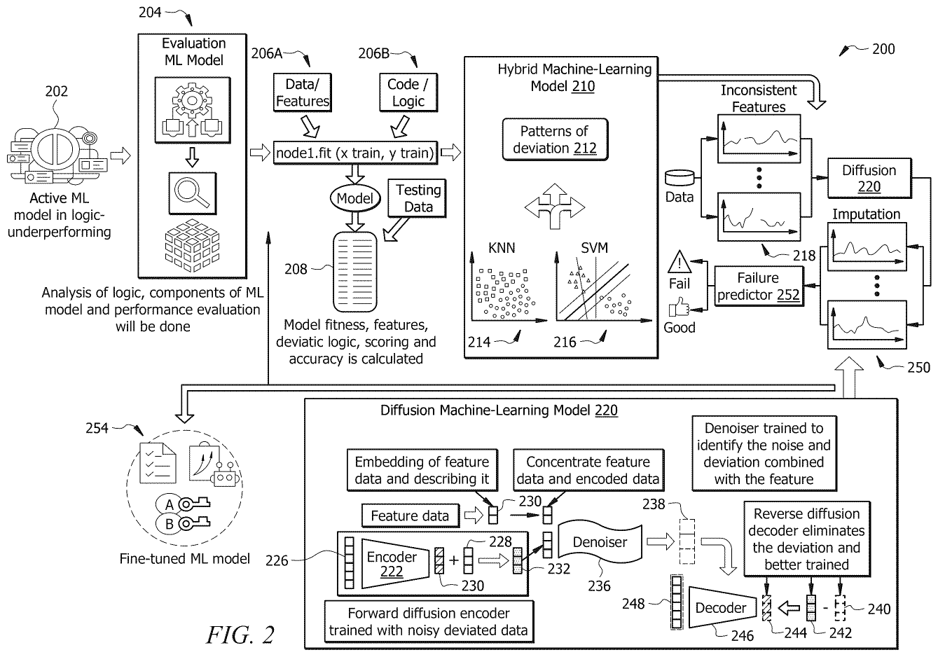

The memory 116 may be volatile or non-volatile and may include a read-only memory (ROM), random-access memory (RAM), ternary content-addressable memory (TCAM), dynamic random-access memory (DRAM), and static random-access memory (SRAM), or other non-transitory computer-readable medium. The memory 116 may be implemented using one or more disks, tape drives, solid-state drives, and/or the like. As will be discussed in greater detail below with respect to FIG. 2, the memory 116 may be operable to store the software application 130, sensitive user data 132, model parameters 134, one or more artificial intelligence (AI)/machine-learning models 144 (e.g., including a diffusion machine-learning model 146, a hybrid machine-learning model 148, and self-supervised machine-learning model 150), one or more input data sets 136, model performance metrics 138, expected prediction outputs 140, set of output data 142, a first set of feature data 152, a second set of feature data 154, patterns of deviation 156, inconsistent features 158, and/or any other data, instructions, or functional blocks that may be associated with training, validating, executing, or otherwise fine-tuning the AI/machine-learning models 144 and/or the active machine-learning model 122.

The memory 116 may also store instances of software application 130 that may be executing within the system 100. In one embodiment, the instances of a software application 130 may include any number of instances a large software application suitable for hosting and servicing thousands or millions of individual users 102 that may interact via user computing devices 104 with the cloud computing system 106. The users 102 may be further associated with the sensitive user data 132.

### Processor(s)

In particular embodiments, the processor(s) 112 may 1) perform a self-supervised training, validation, and execution of an evaluation machine model 150 of one or more generative machine-learning models 144 for evaluating an active machine-learning model 122 identified as underperforming (e.g., generating prediction outputs 128 that deviate from expected prediction outputs 140 in response to an input of one or more of a training data set 124 or an input data set 126); 2) identify and quantify patterns of deviation 156 and inconsistent features 158 associated with the active machine-learning model 122; and 3) dynamically update and rectify the active machine-learning model 122 determined to be underperforming.

### Active Underperforming Machine-Learning Model

In particular embodiments, the computing system 108 may include an active machine-learning model 122, which may be generating prediction outputs (e.g., prediction outputs 128) that deviates from an expected prediction output (e.g., expected prediction output 140). For example, in one embodiment, the active machine-learning model 122 may be any predictive model or other statistical model trained on one or more large training data sets 124 (e.g., financial training data set, user training data set, technical training data set, literature training data set, geographical training data set, and so forth) for generating prediction outputs 128 in response to being inputted a new, but similar input data set (e.g., financial input data set, user input data set, technical input data set, literature input data set, geographical input data set, and so forth). As used herein, an “active machine-learning model” may refer to any machine-learning model that has been trained and validated and is currently deployed (e.g., currently “online”) and actively generating prediction outputs 128 in response to the input data set 126, for example.

### Dynamically Updating and Rectifying Machine-learning Models Determined to be Underperforming

Embodiments of the present disclosure discuss techniques for dynamically updating and rectifying machine-learning models determined to be underperforming.

FIG. 2 illustrates a workflow diagram of an embodiment of a model evaluation and rectification system 200, in accordance with certain aspects of the present disclosure. In particular embodiments, the workflow of the model evaluation and rectification system 200 may be performed utilizing the cloud computing system 106 as described above with respect to FIG. 1. As depicted, the model evaluation and rectification system 200 may begin with identifying an active machine-learning model 202, which is generating prediction outputs (e.g., prediction outputs 128) that deviate from an expected prediction output (e.g., expected prediction output 140).

For example, in one embodiment, the active machine-learning model 202 may be any predictive model or other statistical model trained on one or more large data sets (e.g., financial data, user data, technical data, literature, geographical data, and so forth) for generating prediction outputs in response to being inputted a new, but similar data set (e.g., financial data, user data, technical data, literature, geographical data, and so forth). In accordance with one or more embodiments, the active machine-learning model 202 may be identified as “underperforming,” which may generally refer to a machine-learning model generating prediction outputs with a prediction accuracy of less than “0.7” on a scale of “0.0” to “1.0,” in which a prediction accuracy of “1.0” may indicate a highest likelihood of model prediction accuracy while a prediction accuracy of “0.0” may indicate a lowest likelihood of model prediction accuracy. Specifically, in accordance with the presently disclosed embodiments, a “prediction accuracy” may refer to the percentage of correct predictions that a trained machine learning model achieves, or the number of correct predictions divided by the total number of predictions generated by the machine-learning model.

In particular embodiments, the active machine-learning model 202 including, for example, model parameters 206A, 206B (e.g., codebase, algorithm, logic, training data sets, testing data sets, validation data sets, features, learned parameters, model parameters, deviations, and so forth) may be then provided to an evaluation machine-learning model 204. In particular embodiments, the evaluation machine-learning model 204 may be then in real-time or near real-time trained and validated in accordance with a self-supervised learning (SSL) process based on the model parameters 206A, 206B (e.g., codebase, algorithm, logic, training data sets, testing data sets, validation data sets, features, learned parameters, model parameters, deviations, and so forth) and executed to generate one or more model performance metrics 208 associated with the active machine-learning model 202.

For example, in particular embodiments, the model performance metrics 208 may include one or more of a fitness score, an accuracy performance metric, a precision performance metric, a prediction uncertainty performance metric, a receiver operating characteristic (ROC) curve performance metric, an area under curve (AUC) performance metric, a true positive rate (TPR) performance metric, a false positive rate (FPR), an F1 score performance metric, or other performance metric that may be suitable for quantifying the underperformance of the active machine-learning model 202. For example, in one embodiment, the fitness score may include a model evaluation metric indicative of how well the prediction outputs 128 generated by the active machine-learning model 202 “fit” to the training data set 124, and further how well the prediction outputs 128 generated by the active machine-learning model 202 generalizes broadly to the input data set 126. For example, when the prediction outputs 128 generated by the active machine-learning model 202 “fit” to the training data set 124 too well, it is said that the active machine-learning model 202 is overfitted to the training data set 124. On the other hand, when the prediction outputs 128 generated by the active machine-learning model 202 “fit” to the training data set 124 not well enough, itis said that the active machine-learning model 202 is underfitted to the training data set 124.

Similarly, the F1 score performance metric may include a model evaluation metric indicative of a number of prediction errors that the active machine-learning model 202 is making and the type of errors that are made by the active machine-learning model 202. The precision performance metric may be a subset of the F1 score performance metric along with a recall performance metric. ROC is a probability curve and AUC represents the degree or measure of separability and tells how much the active machine-learning model 202 is capable of distinguishing between classes, such that the higher the AUC, the better the model is at predicting “0” classes as “0” and “1” classes as “1.” The TPR includes a metric that measures the proportion of positive instances that are correctly identified by the active machine-learning model 202, while the FPR includes a metric that measures the proportion of positive instances that are incorrectly identified by the active machine-learning model 202.

In particular embodiments, the model performance metrics 208 may be then compared to a performance metric threshold (e.g., ROC threshold, AUC threshold, TPR threshold, FPR threshold, F1 score threshold, and so forth) to identify and quantify in real-time or near real-time the active machine-learning model 202 as underperforming. For example, in one embodiment, the performance metric threshold may include a fitness score of “0.5,” which may indicate a “sweet spot” between an overfitting and underfitting of the active machine-learning model 202. In such an embodiment, the fitness score (e.g., “0.3”) calculated for the active machine-learning model 202 may be then compared to the performance metric threshold fitness score of “0.5,” and the active machine-learning model 202 may be determined as underperforming (e.g., overfitted) based on its comparison to the performance metric threshold. In particular embodiments, the underperformance of the active machine-learning model 202 may be further identified and quantified by performing one or more situational tests or boundary tests with respect to the model performance metrics 208.

In particular embodiments, upon the evaluation machine-learning model 204 identifying and quantifying the active machine-learning model 202 as underperforming, the model parameters 206A, 206B and the model performance metrics 208 may be then provided to a hybrid machine-learning model 210 that may be trained to identify patterns of deviation 212 of the one or more prediction outputs and inconsistent features 218 in the training data set or input data set associated with the active machine-learning model 202 based on the model parameters 206A, 206B and the model performance metrics 208. As used herein, a “feature” may refer to one or more variables in a data set (e.g., training data set, validation data set, testing data set, input data set) that is most impactful to a model's performance in generating accurate prediction outputs in response to the inputted data set. For example, in one embodiment, the inconsistent features 218 may include any missing features, any missing values, any null values, any irrelevant features, any outlier features, or any other inconsistent features included as part of, for example, the training data set or input data set (e.g., model parameters 206A) associated with the active machine-learning model 202 and that may adversely impact the performance of the active machine-learning model 202.

Specifically, in accordance with one or more embodiments, the hybrid machine-learning model 210 may be utilized to identify the most significant contributors to the underperformance or poor performance of the active machine-learning model 202. For example, in some embodiments, the hybrid machine-learning model 210 may identify the most significant contributors, such as the inconsistent features 218, a quality of training data (e.g., quality of training data set 124), an overfitting and/or underfitting of the active machine-learning model 202, or a quantity of training data (e.g., quantity of training data set 124) that may be most responsible for the active machine-learning model 202 underperforming. Specifically, the quality of training data (e.g., quality of training data set 124) may contribute to the underperformance of the active machine-learning model 202 following a “garbage in, garbage out” rule, which conveys that the active machine-learning model 202 may perform well insofar as the training data set 124 is representative of the target model prediction. That is, returning to an earlier example, a machine-learning model trained to predict a class label of “dog” for images of a large data set of images of animals would first have to be accurately trained upon thousands (or millions) of images of dogs before the machine-learning model could be reasonably expected to correctly identify images of dogs.

Similarly, when the prediction outputs 128 generated by the active machine-learning model 202 “fit” to the training data set 124 too well, it is said that the active machine-learning model 202 is overfitted to the training data set 124, for example. On the other hand, when the prediction outputs 128 generated by the active machine-learning model 202 “fit” to the training data set 124 not well enough, it is said that the active machine-learning model 202 is underfitted to the training data set 124. Overfitting and underfitting may be significant contributors to the active machine-learning model 202 underperforming.

The quantity of training data (e.g., quality of training data set 124) may contribute to the underperformance of the active machine-learning model 202 in that if the active machine-learning model 202 was not trained on a large enough number of examples in the training data set 124, the active machine-leaning model 202 may underperform once provided an input data set 126 that includes data that do not respond to the limited examples shown to the active machine-learning model 202 during training. Lastly, the inconsistent features 218 may include any missing features, any missing values, any null values, any irrelevant features, any outlier features, or any other features included as part of, for example, the training data set 124 or the input data set 126 that may be contributing to the active machine-learning model 202 underperforming (e.g., generating prediction outputs 128 that do not correspond to expected prediction outputs 140) on the training data set 124 or the input data set 126.

In particular embodiments, as further depicted by FIG. 2, the hybrid machine-learning model 210 may include a k-nearest neighbor (KNN) machine-learning model 214 that may be suitable for identifying the inconsistent features 218 (e.g., missing features, missing values, null values, irrelevant features, outlier features, and so forth) by performing one or more of a classification or regression based on the performance metrics and the training data set or input data set (e.g., model parameters 206A) associated with the active machine-learning model 202.

In particular embodiments, as further depicted by FIG. 2, the hybrid machine-learning model 210 may include a support vector machine (SVM) 216 that may be suitable for identifying patterns of deviation 212 (e.g., patterns of the deviations of between the prediction outputs 128 and the expected prediction outputs 140) by performing one or more of a classification or regression based on the model performance metrics 208 and the one or more prediction outputs 128. Specifically, the SVM 216 may receive the model performance metrics 208, the prediction outputs 128, and the expected prediction outputs 140 and generate a function (e.g., hyperplane) that classifies the deviations (e.g., differences) between the prediction outputs 128 and the expected prediction outputs 140.

By including the KNN model 214, the hybrid machine-learning model 210 may be suitable for executing on training data sets or input data sets (e.g., model parameters 206A) that include inconsistent features 218 (e.g., missing features, missing values, null values, irrelevant features, outlier features, and so forth). Similarly, by including the SVM 216, the hybrid machine-learning model 210 may be suitable for determining a hyperplane that best separates the deviations (e.g., differences) between the prediction outputs 128 and the expected prediction outputs 140 into separate domains as indicative of the patterns of deviations 212. In this way, the hybrid machine-learning model 210 may be utilized to identify and quantify the “how” and “why” as to the reason the active machine-learning model 202 is generating the one or more prediction outputs 128 that is deviating from the expected prediction output 140.

In particular embodiments, upon the hybrid machine-learning model 210 identifying the patterns of deviation 212 (e.g., hyperplane of differences between the prediction outputs 128 and the expected prediction outputs 140) and the inconsistent features 218 (e.g., missing features, missing values, null values, irrelevant features, outlier features, and so forth), the identified patterns of deviation 212 and the inconsistent features 218 may be then passed to a diffusion machine-learning model 220 that may be trained and executed to rectify and fine-tune (e.g., by way of parameter-efficient fine-tuning (PEFT)) the active machine-learning model 202 by imputing the inconsistent features 218 (e.g., missing features, missing values, null values, irrelevant features, outlier features) utilizing the patterns of deviation 212. Specifically, as discussed in greater detail below, the diffusion machine-learning model 220 may be trained to transform a feature vector or image into noise by iteratively adding noise to the feature vector or image and then to transform that noise into an improved feature vector or image by predicting the noise added to the feature vector or image, and then subtracting the predicted noise from the feature vector or image as part of a generative artificial-intelligence (AI) process.

For example, in particular embodiments, the diffusion machine-learning model 220 may include a forward diffusion encoder 222 that may be trained and executed to receive a first set of feature data 226 and to generate an encoded feature data 228. For example, in one embodiment, the first set of feature data 226 may include an n-dimensional feature vector describing, for example, the patterns of deviation 212 and/or the inconsistent features 218. The encoded feature data 228 may represent a down-sampling of the first set of feature data 226. As further depicted by FIG. 2, the diffusion machine-learning model 220 may then combine the encoded feature data 228 and a set of noisy deviation data 230 to generate a combined feature and noisy deviation data set 232. In one embodiment, the set of noisy deviation data 230 may include random noise data at least partially determined based on the patterns of deviation 212 identified by the SVM 216 of the hybrid machine-learning model 210 as discussed above.

Specifically, as will be further appreciated, in accordance with one or more embodiments, the forward diffusion encoder 222 and a denoiser 236 (e.g., denoising autoencoder) may execute a forward diffusion process for ultimately transforming the first set of feature data 226 into a pure noise 238 while the reverse diffusion decoder 246 may execute a reverse diffusion process for transforming the pure noise 238 into an improved representation of the first set of feature data 226. Indeed, this improved representation of the first set of feature data 226 constitutes the first set of feature data 226 in which any inconsistent features 218, such as missing features or missing values, having been imputed by the diffusion machine-learning model 220 (e.g., as part of a generative AI process).

For example, in particular embodiments, the forward diffusion encoder 222 and the denoiser 236 (e.g., denoising autoencoder) may in conjunction generate a prediction of the pure noise 238 and the encoded feature data 228 based on the combined feature and noisy deviation data set 232. In particular embodiments, upon the forward diffusion encoder 222 and the denoiser 236 (e.g., denoising autoencoder) generating the prediction of the pure noise 238 and the encoded feature data 228 based on the combined feature and noisy deviation data set 232, the reverse diffusion decoder 246 may be trained and executed to regenerate an imputed set of feature data 248 (e.g., an imputed representation of the first set of feature data 226) by subtracting the set of noisy deviation data 230 from the combined feature and noisy deviation data set 232. In other words, the reverse diffusion decoder 246 may regenerate consistent feature data for the active machine-learning model 202, and thus rectify and fine-tune the active machine-learning model 202 by imputing the inconsistent features 218 (e.g., missing features, missing values, null values, irrelevant features, outlier features, and so forth) within the combined feature and noisy deviation data set 232.

In particular embodiments, the diffusion machine-learning model 220 may then generate a set of output data 250 (e.g., imputed feature data) based on the imputed set of feature data 248 (e.g., an imputed representation of the first set of feature data 226). In response to determining that the set of output data 250 (e.g., imputed feature data) satisfies a predetermined accuracy threshold (e.g., a prediction accuracy of “0.8”; “0.9”; or “1.0” on the scale of “0.0” to “1.0,” in which a prediction accuracy of “1.0” may indicate a highest likelihood of model prediction accuracy while a prediction accuracy of “0.0” may indicate a lowest likelihood of model prediction accuracy) determine by way of accuracy prediction model 252, the diffusion machine-learning model 220 may then provide the set of output data 250 (e.g., imputed feature data) to the active machine-learning model 202 based on which the active machine-learning model 202 may be fine-tuned (e.g., by way of parameter-efficient fine-tuning (PEFT)) to generate a fine-tuned active machine-learning model 254. In this way, the present embodiments may in real-time or near real-time rectify and fine-tune the active machine-learning model 202, such that the fine-tuned active machine-learning model 254 subsequently generates prediction outputs in accordance with its expected prediction output (e.g., expected prediction output 140).

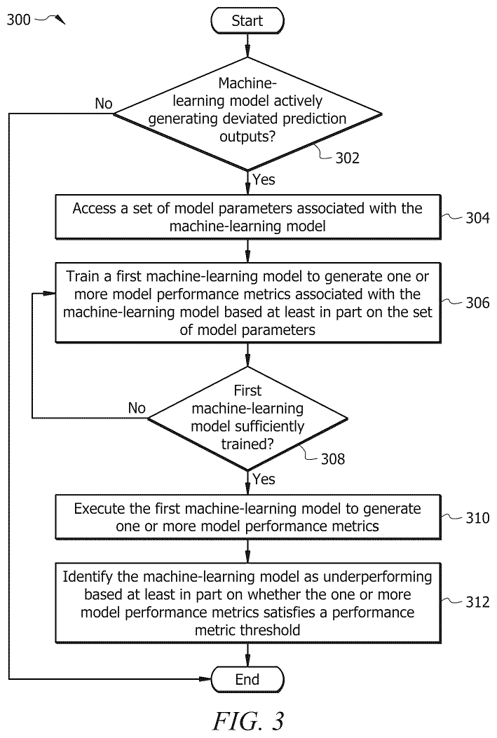

FIG. 3 illustrates a flowchart of an example method 300 for performing a self-supervised training, validation, and execution of an evaluation model for evaluating underperforming machine-learning models, in accordance with one or more embodiments of the present disclosure. The method 300 may be performed utilizing the one or more processor(s) 112 of cloud computing system 106 as described above with respect to FIG. 1. The method 300 may begin at decision 302 with the processor(s) 112 determining at decision 302 whether an active machine-learning model 202 is actively generating deviated prediction outputs (e.g., deviated prediction outputs 128).

In one embodiment, in response to confirming that the active machine-learning model 202 is not actively generating deviated prediction outputs (e.g., at decision 302), the method 300 may terminate (e.g., “end”). On the other hand, in response to confirming that the active machine-learning model 202 is actively generating deviated prediction outputs (e.g., at decision 302), the method 300 may then continue at block 304 with the processor(s) 112 accessing a set of model parameters associated with the machine-learning model. The method 300 may then continue at block 306 with the processor(s) 112 training a first machine-learning model (e.g., evaluation machine-learning model 204) to generate one or more model performance metrics associated with the active machine-learning model 202 based at least in part on the set of model parameters.

The method 300 may continue with the processor(s) 112 determining at decision 308 whether the first machine-learning model (e.g., evaluation machine-learning model 204) is sufficiently trained. In one embodiment, in response to confirming that the first machine-learning model (e.g., evaluation machine-learning model 204) is not sufficiently trained (e.g., at decision 308), for example, in accordance with a self-supervised learning (SSL) process, the method 300 may return to block 306 as discussed above.

On the other hand, in response to confirming that the first machine-learning model (e.g., evaluation machine-learning model 204) is sufficiently trained (e.g., at decision 302), for example, in accordance with a self-supervised learning (SSL) process, the method 300 may then continue at block 310 with the processor(s) 112 accessing a set of model parameters associated with the active machine-learning model 202. The method 300 may then conclude at block 312 with the processor(s) 112 identifying the active machine-learning model 202 as underperforming based at least in part on whether the one or more model performance metrics satisfies a performance metric threshold.

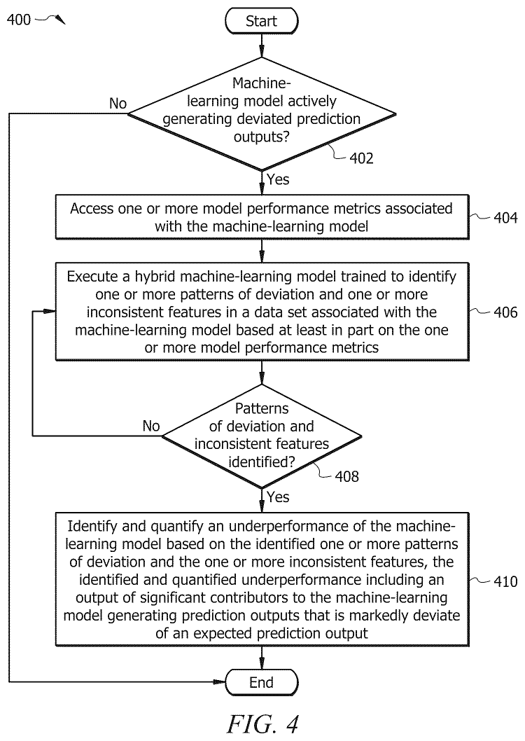

FIG. 4 illustrates a flowchart of an example method 400 for identifying and quantifying deviations and inconsistent features in machine-learning models, in accordance with one or more embodiments of the present disclosure. The method 400 may be performed utilizing the one or more processor(s) 112 of cloud computing system 106 as described above with respect to FIG. 1. The method 400 may begin at decision 402 with the processor(s) 112 confirming whether an active machine-learning model 202 is actively generating deviated prediction outputs (e.g., deviated prediction outputs 128).

In one embodiment, in response to confirming that the active machine-learning model 202 is not actively generating deviated prediction outputs (e.g., at decision 402), the method 400 may terminate (e.g., “end”). On the other hand, in response to confirming that the active machine-learning model 202 is actively generating deviated prediction outputs (e.g., at decision 402), the method 400 may then continue at block 404 with the processor(s) 112 accessing one or more model performance metrics associated with the active machine-learning model 202. The method 400 may then continue at block 406 with the processor(s) 112 executing a hybrid machine-learning model (e.g., hybrid machine-learning model 210) trained to identify one or more patterns of deviation 212 and one or more inconsistent features 218 in a data set associated with the active machine-learning model 202 based at least in part on the one or more model performance metrics.

The method 400 may then continue with the processor(s) 112 determining at decision 408 whether the one or more patterns of deviation 212 and the one or more inconsistent features 218 have been identified. In one embodiment, in response to confirming that the one or more patterns of deviation 212 and the one or more inconsistent features 218 have not been identified (e.g., at decision 408), the method 400 may return to block 406 as discussed above.

On the other hand, in response to confirming that the one or more patterns of deviation 212 and the one or more inconsistent features 218 have been identified, the method 400 may then conclude at block 410 with the processor(s) 112 identifying and quantifying an underperformance of the active machine-learning model 202 based on the identified one or more patterns of deviation 212 and the one or more inconsistent features 218, in which the identified and quantified underperformance includes an output of significant contributors to the active machine-learning model 202 generating prediction outputs (e.g., deviated prediction outputs 128) that deviate from an expected prediction output (e.g., expected prediction outputs 140).

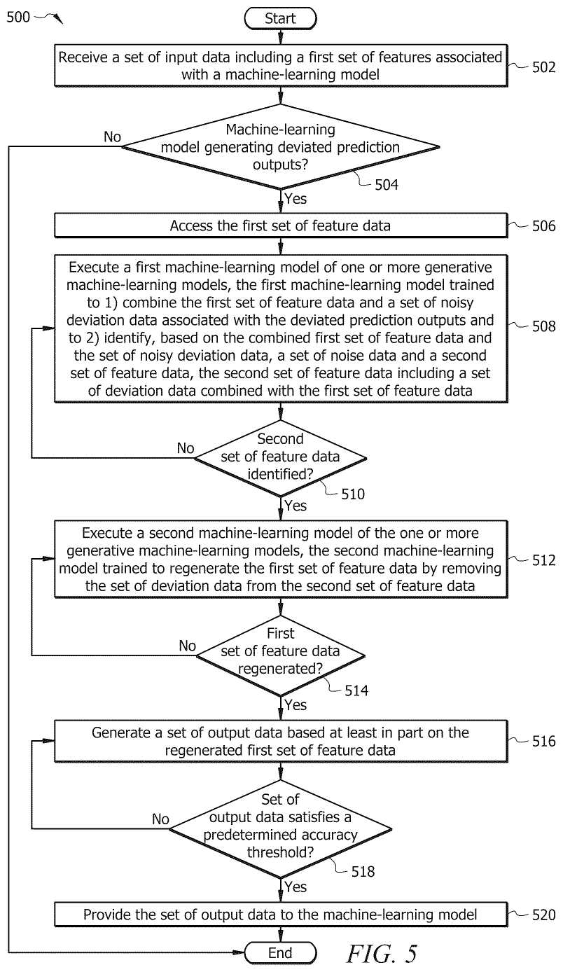

FIG. 5 illustrates a flowchart of an example method 500 for dynamically updating and rectifying machine-learning models determined to be underperforming, in accordance with one or more embodiments of the present disclosure. The method 500 may be performed utilizing the one or more processor(s) 112 of cloud computing system 106 as described above with respect to FIG. 1. The method 500 may begin at block 502 with the processor(s) 112 receiving a set of input data including a first set of features associated with an active machine-learning model 202.

The method 500 may then continue at decision 504 with the processor(s) 112 determining whether the active machine-learning model 202 is actively generating deviated prediction outputs (e.g., deviated prediction outputs 128). In one embodiment, in response to confirming that the active machine-learning model 202 is not actively generating deviated prediction outputs (e.g., at decision 504), the method 500 may terminate (e.g., “end”). On the other hand, in response to confirming that the active machine-learning model 202 is actively generating deviated prediction outputs (e.g., at decision 504), the method 500 may then continue at block 506 with the processor(s) 112 accessing the first set of feature data 152.

The method 500 may then continue at block 508 with the processor(s) 112 executing a first machine-learning model (e.g., forward diffusion encoder 222) of one or more generative machine-learning models (e.g., diffusion machine-learning model 220), in which the first machine-learning model (e.g., forward diffusion encoder 222) is trained to 1) combine the first set of feature data and a set of noisy deviation data associated with the deviated prediction outputs and to 2) identify, based on the combined first set of feature data 152 and the set of noisy deviation data, a set of noise data and a second set of feature data 154, in which the second set of feature data 154 includes a set of deviation data combined with the first set of feature data 152.

The method 500 may then continue with the processor(s) 112 confirming at decision 510 whether the second set of feature data 154 has been identified. In one embodiment, in response to confirming that the second set of feature data 154 has not been identified (e.g., at decision 510), the method 500 may return to block 508 as discussed above. On the other hand, in response to confirming that the second set of feature data 154 has been identified (e.g., at decision 510), the method 500 may then continue at block 512 with the processor(s) 112 executing a second machine-learning model (e.g., reverse diffusion decoder 246) of the one or more generative machine-learning models (e.g., diffusion machine-learning model 220), in which the second machine-learning model (e.g., reverse diffusion decoder 246) is trained to regenerate the first set of feature data 152 by removing the set of deviation data from the second set of feature data 154.

The method 500 may then continue with the processor(s) 112 confirming at decision 514 whether the first set of feature data 152 has been regenerated. In one embodiment, in response to confirming that the first set of feature data 152 has not been regenerated (e.g., at decision 514), the method 500 may return to block 512 as discussed above. On the other hand, in response to confirming that the first set of feature data 152 has been regenerated (e.g., at decision 514), the method 500 may then continue at block 516 with the processor(s) 112 generating a set of output data 142 based at least in part on the regenerated first set of feature data 152.

The method 500 may then continue with the processor(s) 112 determining at decision 518 whether the set of output data 142 satisfies a predetermined accuracy threshold. In response to determining that the set of output data 142 fails to satisfy the predetermined accuracy threshold (e.g., at decision 518), the method 500 may return to block 516 as discussed above. On the other hand, in response to determining that the set of output data 142 satisfies the predetermined accuracy threshold (e.g., at decision 518), the method 500 may then conclude at block 520 with the processor(s) 112 providing the set of output data 142 to the active machine-learning model 202.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

To aid the Patent Office, and any readers of any patent issued on this application in interpreting the claims appended hereto, applicants note that they do not intend any of the appended claims to invoke 35 U.S.C. § 112(f) as it exists on the date of filing hereof unless the words “means for” or “step for” are explicitly used in the particular claim.

1. A system, comprising:
a memory configured to store a set of input data, wherein the set of input data comprises a first set of feature data associated with a machine-learning model, wherein the machine-learning model is identified as having generated one or more prediction outputs that deviates from an expected prediction output; and
one or more processors operably coupled to the memory and configured to:
access the first set of feature data;
execute a first machine-learning model of one or more generative machine-learning models, wherein the first machine-learning model is trained 1) to combine the first set of feature data and a set of noisy deviation data associated with the one or more prediction outputs, and 2) to identify, based at least in part on the combined first set of feature data and the set of noisy deviation data, a set of noise data and a second set of feature data, wherein the second set of feature data comprises a set of deviation data combined with the first set of feature data;
execute a second machine-learning model of the one or more generative machine-learning models, wherein the second machine-learning model is trained to regenerate the first set of feature data by removing the set of deviation data from the second set of feature data;
generate a set of output data based at least in part on the regenerated first set of feature data; and
in response to determining that the set of output data satisfies a predetermined accuracy threshold, provide the set of output data to the machine-learning model.

2. The system of claim 1, wherein the one or more generative machine-learning models comprises a diffusion machine-learning model.

3. The system of claim 2, wherein the diffusion machine-learning model comprises one or more of a fully convolutional network (FCN), a U-Net diffusion model, a Midjourney diffusion model, a Stable Diffusion model, a DALL-E diffusion, or a denoising diffusion probabilistic model (DDPM).

4. The system of claim 2, wherein the first machine-learning model comprises a forward diffusion encoder of the diffusion machine-learning model.

5. The system of claim 2, wherein the second machine-learning model comprises a reverse diffusion decoder of the diffusion machine-learning model.

6. The system of claim 1, wherein the one or more processors are further configured to fine-tune the machine-learning model based at least in part on the set of output data.

7. The system of claim 1, wherein the second machine-learning model is further trained to regenerate the first set of feature data by imputing one or more inconsistent features in the second set of feature data.

8. A method, comprising:
accessing a set of input data, wherein the set of input data comprises a first set of feature data associated with a machine-learning model, and wherein the machine-learning model is identified as having generated one or more prediction outputs that deviate from an expected prediction output;
executing a first machine-learning model of one or more generative machine-learning models, wherein the first machine-learning model is trained 1) to combine the first set of feature data and a set of noisy deviation data associated with the one or more prediction outputs, and 2) to identify, based at least in part on the combined first set of feature data and the set of noisy deviation data, a set of noise data and a second set of feature data, wherein the second set of feature data comprises a set of deviation data combined with the first set of feature data;
executing a second machine-learning model of the one or more generative machine-learning models, wherein the second machine-learning model is trained to regenerate the first set of feature data by removing the set of deviation data from the second set of feature data;
generating a set of output data based at least in part on the regenerated first set of feature data; and
in response to determining that the set of output data satisfies a predetermined accuracy threshold, providing the set of output data to the machine-learning model.

9. The method of claim 8, wherein the one or more generative machine-learning models comprises a diffusion machine-learning model.

10. The method of claim 9, wherein the diffusion machine-learning model comprises one or more of a fully convolutional network (FCN), a U-Net diffusion model, a Midjourney diffusion model, a Stable Diffusion model, a DALL-E diffusion, or a denoising diffusion probabilistic model (DDPM).

11. The method of claim 9, wherein the first machine-learning model comprises a forward diffusion encoder of the diffusion machine-learning model.

12. The method of claim 9, the second machine-learning model comprises a reverse diffusion decoder of the diffusion machine-learning model.

13. The method of claim 8, further comprising fine-tuning the machine-learning model based at least in part on the set of output data.

14. The method of claim 8, wherein the second machine-learning model is further trained to regenerate the first set of feature data by imputing one or more inconsistent features in the second set of feature data.

15. A non-transitory computer-readable medium storing instructions that, when executed by one or more processors, cause the one or more processors to:
access a set of input data, wherein the set of input data comprises a first set of feature data associated with a machine-learning model, and wherein the machine-learning model is identified as having generated one or more prediction outputs that deviate from an expected prediction output;
execute a first machine-learning model of one or more generative machine-learning models, wherein the first machine-learning model is trained 1) to combine the first set of feature data and a set of noisy deviation data associated with the one or more prediction outputs, and 2) to identify, based at least in part on the combined first set of feature data and the set of noisy deviation data, a set of noise data and a second set of feature data, wherein the second set of feature data comprises a set of deviation data combined with the first set of feature data;
execute a second machine-learning model of the one or more generative machine-learning models, wherein the second machine-learning model is trained to regenerate the first set of feature data by removing the set of deviation data from the second set of feature data;
generate a set of output data based at least in part on the regenerated first set of feature data; and
in response to determining that the set of output data satisfies a predetermined accuracy threshold, provide the set of output data to the machine-learning model.

16. The non-transitory computer-readable medium of claim 15, wherein the one or more generative machine-learning models comprises a diffusion machine-learning model.

17. The non-transitory computer-readable medium of claim 16, wherein the diffusion machine-learning model comprises one or more of a fully convolutional network (FCN), a U-Net diffusion model, a Midjourney diffusion model, a Stable Diffusion model, a DALL-E diffusion, or a denoising diffusion probabilistic model (DDPM).

18. The non-transitory computer-readable medium of claim 16, wherein the first machine-learning model comprises a forward diffusion encoder of the diffusion machine-learning model, and wherein the second machine-learning model comprises a reverse diffusion decoder of the diffusion machine-learning model.

19. The non-transitory computer-readable medium of claim 15, wherein the instructions further cause the one or more processors to fine-tune the machine-learning model based at least in part on the set of output data.

20. The non-transitory computer-readable medium of claim 15, wherein the second machine-learning model is further trained to regenerate the first set of feature data by imputing one or more inconsistent features in the second set of feature data.
